(19) United States
(12) Patent Application Publication
(10) Pub. No.: US 2008/0231636 A1
(43) Pub. Date: Sep. 25, 2008

(54) METHOD OF RECOGNIZING WAVEFORMS AND DYNAMIC FAULT DETECTION METHOD USING THE SAME

(75) Inventors: Cheng Jer Yang, Taoyuan County (TW); Shu Ching Yang, Taoyuan County (TW); Hong Ming Chang, Taipei City (TW); Hung Wen Chiou, Hsinchu City (TW)

Correspondence Address: WPAT, PC;INTELLECTUAL PROPERTY ATTORNEYS, 2030 MAIN STREET, SUITE 1300, IRVINE, CA, 92614, US

(73) Assignee: PROMOS TECHNOLOGIES INC., Hsinchu (TW)

(21) Appl. No.: 11/747,159

(22) Filed: May 10, 2007

(30) Foreign Application Priority Data
Mar. 23, 2007 (TW) 096110031

(51) Int. Cl. G06T 11/20

(52) U.S. Cl. 345/440.1

(57) ABSTRACT

A dynamic fault detection method comprises the steps of acquiring a data curve from a machine, performing a waveform-recognition process to check if the data curve includes an effective waveform, performing a data-diagnosing process to check if the value of the effective waveform in an effective region falls outside a predetermined range, and generating an alarm signal if the value of the effective waveform in the effective region falls outside the predetermined range. The waveform-recognition process comprises the steps of checking if the data curve includes a first segment, a second segment and a third segment sandwiched between the first segment and the second segment, and checking if the length of the third segment is larger than a predetermined value. The waveform is determined to include the effective waveform if the checking results are true.

### BACKGROUND OF THE INVENTION

(A) Field of the Invention

The present invention relates to a method for recognizing waveforms and a dynamic fault detection method using the same, and more particularly, to a method for recognizing waveforms and a dynamic fault detection method using the same to solve the data-drifting problem.

(B) Description of the Related Art

FIG. 1 and FIG. 2 show a static fault detection method according to the prior art. The conventional method acquires a data curve 10 from a machine in a factory building, and the parameter of the data curve can be the pressure in a reaction chamber, the flow rate of reaction gases, the concentration of gases or electrical properties such as resistance. The conventional method then checks if the parameter value of the data curve 10 in an effective region 16 is less than the predetermined lower limit 12 or exceeds the upper limit 14 to determine if the machine operates abnormally, and generates an alarm signal if the checking result is true.

However, it is inevitable that data-drifting problems occur with the machine, and the data-drifting problem originates from the difference in end point detection, data loss, signal propagation delay or fabrication time variation. The data-drifting problem causes the data curve to right shift to form drafting curve 10′ with its parameter value in the effective region 16 less than the predetermined lower limit 12 or exceeding the upper limit 14, and the conventional method accordingly generates a false alarm, as shown in FIG. 2.

### SUMMARY OF THE INVENTION

One aspect of the present invention provides a method for recognizing waveforms and a dynamic fault detection method using the same to solve the data-drifting problem.

A dynamic fault detection method according to this aspect of the present invention comprises the steps of acquiring a data curve from a machine, performing a waveform-recognition process to check if the data curve includes an effective waveform, performing a data-diagnosing process to check if the value of the effective waveform in an effective region falls outside a predetermined range, and generating an alarm signal if the value of the effective waveform in the effective region falls outside the predetermined range. The waveform-recognition process comprises the steps of checking if the data curve includes a first segment, a second segment and a third segment sandwiched between the first segment and the second segment, and checking if the length of the third segment is larger than a predetermined value. The waveform is determined to include the effective waveform if the checking results are true.

The conventional static fault detection method tends to generate false alarm signals due to the data-drifting problem. In contrast, the dynamic fault detection method of the present invention can effectively avoid the generation of false alarm signals by using the waveform-recognition process to identify the effective region of the data curve so as to avoid the data-drifting problem, checking if the parameter value of the data curve in the effective region is less than the predetermined lower limit or exceeds the upper limit, and generating the alarm signal if the checking result is true.

### BRIEF DESCRIPTION OF THE DRAWINGS

The objectives and advantages of the present invention will become apparent upon reading the following description and upon reference to the accompanying drawings in which:

FIG. 1 and FIG. 2 show a static fault detection method according to the prior art; and

FIG. 3 and FIG. 4 show a dynamic fault detection method according to one embodiment of the present invention.

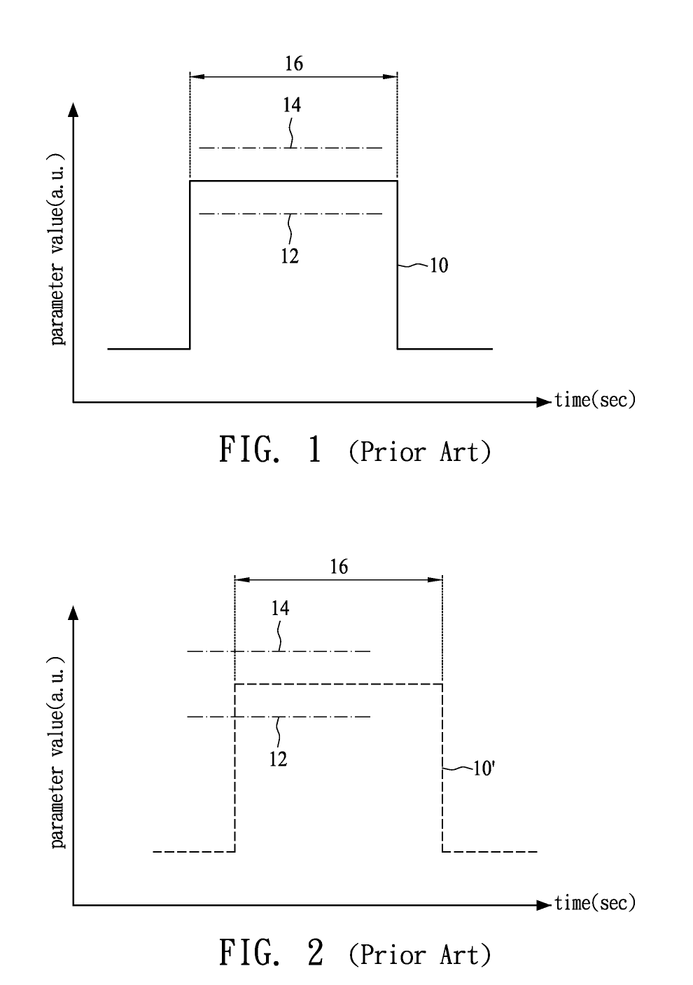

### DETAILED DESCRIPTION OF THE INVENTION

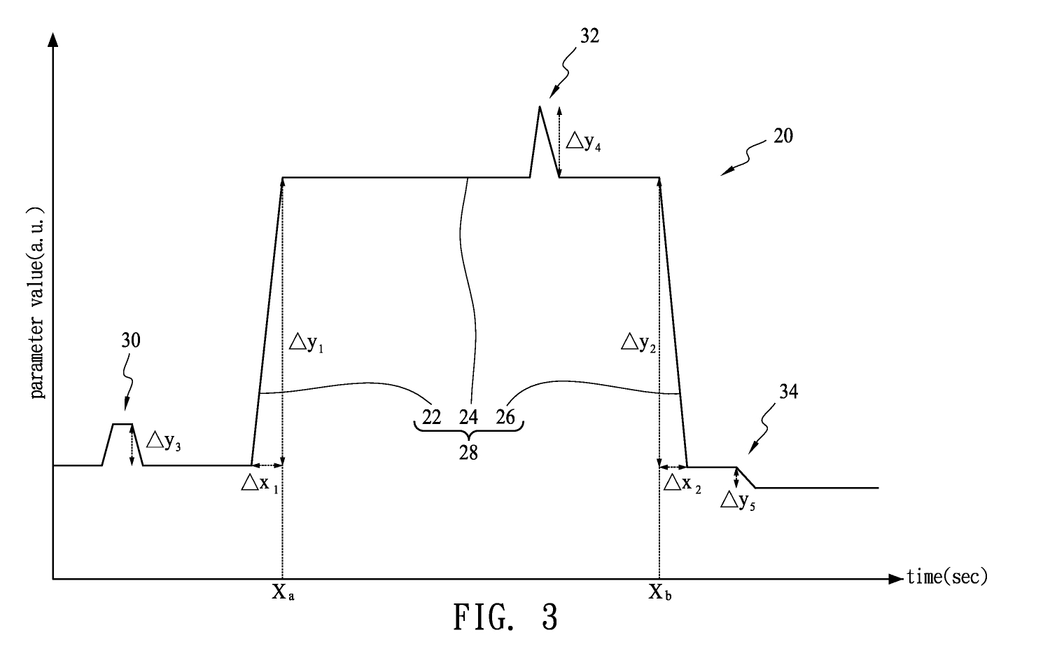

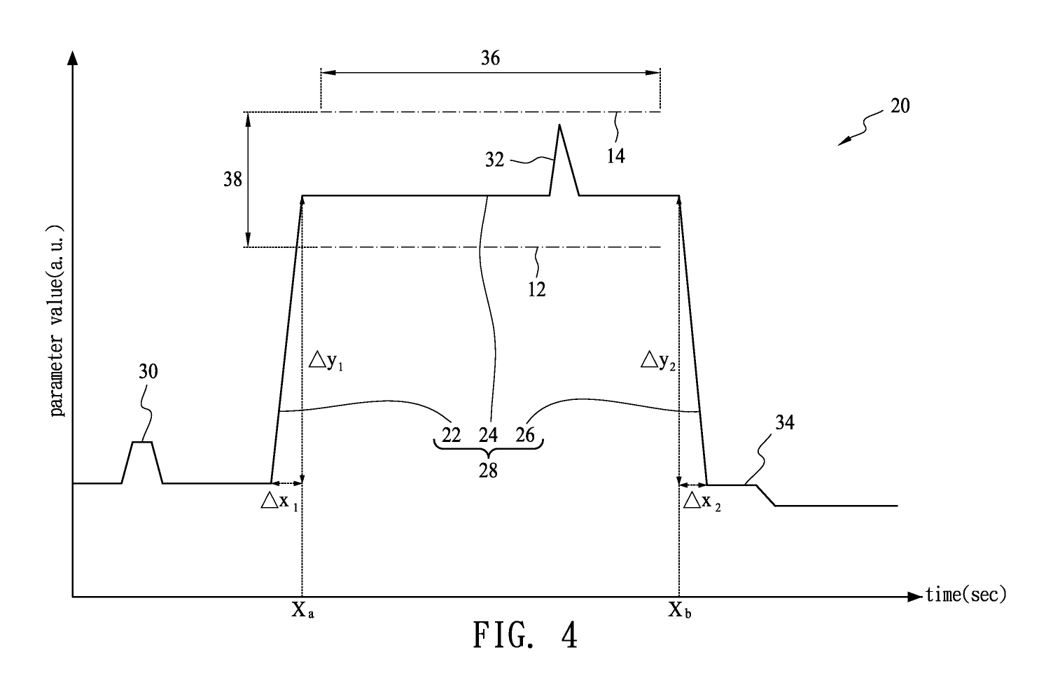

FIG. 3 and FIG. 4 show a dynamic fault detection method according to one embodiment of the present invention. The dynamic fault detection method first acquires a data curve 20 from a machine in a factory building, and the parameter of the data curve 20 can be the pressure in a reaction chamber, the flow rate of reaction gases, the concentration of gases or the electrical properties such as resistance. A waveform-recognition process is performed to check if the data curve 10 includes an effective waveform 28.

The waveform-recognition process checks if the data curve 20 includes a first segment 22, a second segment 26 and a third segment 24 sandwiched between the first segment 22 and the second segment 26, and checks if the length (X_{b}-Xₐ) of the third segment 26 is larger than a first predetermined value depending on the fabrication time or measurement time. The waveform-recognition process then checks if the slope (Δy₁/Δx₁) of the first segment 22 is larger than a second predetermined value and the absolute value of the slope (Δy₂/Δx₂) of the second segment 26 is larger than a third predetermined value. In general, the parameter value such as the pressure of the reaction chamber increases from a low level to a high level as the fabrication process initiates, and the first segment 22 corresponds to this variation trend. Similarly, the parameter value drops from the high level to the low level as the fabrication process is completed, and the second segment 26 corresponds to this variation trend.

The waveform-recognition process then checks if the first segment 22 is directly connected to the third segment 24 and the second segment 26 is directly connected to the third segment 24. In general, the parameter value of the data curve 20 remains at the high level during the fabrication process, and the third segment 24 corresponds to the variation trend as the fabrication process is ongoing. Consequently, the three noises 30, 32 and 34 can be filtered, and the first segment 22, the second segment 26 and third segment 24 are determined to form an effective waveform 28. The first segment 22, the second segment 26 and third segment 24 can be linear or curvy.

In particular, although the noise 30 includes a first segment, third segment and second segment, the length of the third is smaller than the first predetermined value and the noise 30 is not determined to be one effective waveform 28. In addition, the noise 32 includes a first segment and a second segment but lacks a third segment, and is not determined to be one effective waveform 28. Furthermore, the noise 34 includes a third segment and a second segment but lacks a first segment, and is not determined to be one effective waveform 28.

Referring to FIG. 4, after the waveform-recognition process, a data-diagnosing process is performed to check if the parameter value of the effective waveform 28 in an effective region 36 falls outside a predetermined range 38, and generates an alarm signal if the parameter value of the effective waveform 28 in the effective region 36 falls outside the predetermined range 38. In particular, the waveform-recognition process sets a lower limit 12 and an upper limit 14 of the predetermined range 38, checks if the parameter value of the effective waveform 28 in the effective region 36 is smaller than the lower limit 12 and generates the alarm signal if the checking result is true, and checks if the parameter value of the effective waveform 28 in the effective region 36 is larger than the upper limit 14 and generates the alarm signal if the checking result is true. Consequently, the comparison of the lower limit 12 (the upper limit 14) with the parameter value of the data curve 20 in the effective region 36 is dynamically performed to avoid generating a false alarm due to the data-drifting problem.

The conventional static fault detection method tends to generate false alarm signals due to the data-drifting problem. In contrast, the dynamic fault detection method of the present invention can effectively avoid the generation of false alarm signals by using the waveform-recognition process to identify the effective region 36 of the data curve 20 so as to avoid the data-drifting problem, checking if the parameter value of the data curve 20 in the effective region 36 is less than the predetermined lower limit 12 or exceeds the upper limit 14, and generates the alarm signal if the checking result is true.

The above-described embodiments of the present invention are intended to be illustrative only. Numerous alternative embodiments may be devised by those skilled in the art without departing from the scope of the following claims.

What is claimed is:

1. A method for recognizing waveforms, comprising the steps of:
checking if a data curve includes a first segment, a second segment and a third segment sandwiched between the first segment and the second segment;
checking if the length of the third segment is larger than a first value; and
determining the waveform to include an effective waveform if the checking results are true.

2. The method for recognizing waveforms of claim 1, further comprising a step of checking if the slope of the first segment is larger than a second value.

3. The method for recognizing waveforms of claim 1, further comprising a step of checking if the slope of the second segment is larger than a third value.

4. The method for recognizing waveforms of claim 1, further comprising a step of checking if the first segment is directly connected to the third segment.

5. The method for recognizing waveforms of claim 1, further comprising a step of checking if the second segment is directly connected to the third segment.

6. The method for recognizing waveforms of claim 1, wherein the first segment, the second segment and the third segment are linear.

7. The method for recognizing waveforms of claim 1, wherein the first segment, the second segment and the third segment are curvy.

8. A dynamic fault detection method, comprising the steps of:
acquiring a data curve from a machine;
performing a waveform-recognition process to check if the data curve includes an effective waveform; and
performing a data-diagnosing process to check if the value of the effective waveform in an effective region falls outside a predetermined range, and generating an alarm signal if the value of the effective waveform in the effective region falls outside the predetermined range.

9. The dynamic fault detection method of claim 8, wherein the waveform-recognition process comprises the steps of:
checking if the data curve includes a first segment, a second segment and a third segment sandwiched between the first segment and the second segment;
checking if the length of the third segment is larger than a first value; and
determining the waveform to include an effective waveform if the checking results are true.

10. The dynamic fault detection method of claim 9, wherein the waveform-recognition process further comprises a step of checking if the slope of the first segment is larger than a second value.

11. The dynamic fault detection method of claim 9, wherein the waveform-recognition process further comprises a step of checking if the slope of the second segment is larger than a third value.

12. The dynamic fault detection method of claim 9, wherein the waveform-recognition process further comprises a step of checking if the first segment is directly connected to the third segment.

13. The dynamic fault detection method of claim 9, wherein the waveform-recognition process further comprises a step of checking if the second segment is directly connected to the third segment.

14. The dynamic fault detection method of claim 8, wherein the data-diagnosing process comprises the steps of:
checking if the value of the effective waveform in the effective region is smaller than a lower limit, and generating the alarm signal if the checking result is true; and
checking if the value of the effective waveform in the effective region is larger than an upper limit, and generating the alarm signal if the checking result is true.

15. The dynamic fault detection method of claim 8, further comprising a step of setting a lower limit and an upper limit.
